(19) United States
(12) Patent Application Publication
(10) Pub. No.: US 2025/0080158 A1
(43) Pub. Date: Mar. 6, 2025

(54) IMPEDANCE MATCHING IN RADIO-FREQUENCY COMMUNICATIONS

(71) Applicant: Nordic Semiconductor ASA, Trondheim (NO)

(72) Inventors: Francesco PINI, Trondheim (NO); Wayne WOO, Trondheim (NO)

(73) Assignee: Nordic Semiconductor ASA, Trondheim (NO)

(21) Appl. No.: 18/825,979

(22) Filed: Sep. 5, 2024

(30) Foreign Application Priority Data
Sep. 6, 2023 (GB) 2313600.5

(51) Int. Cl. H04B 1/40

(52) U.S. Cl. CPC H04B 1/40

(57) ABSTRACT

A radio-frequency transceiver is operable to transmit one or more radio-frequency signals via an antenna in a transmitter mode and to receive one or more radio-frequency signals via the antenna in a receiver mode. The transceiver comprises a power amplifier for use in the transmitter mode comprising a switched-capacitor array comprising a plurality of capacitance elements, and a low-noise amplifier for use in the receiver mode. The transceiver is configured, when operating in the receiver mode, to pull one or more of the capacitance elements in the switched-capacitor array to a ground potential.

### CROSS REFERENCE TO RELATED APPLICATION

This application claims priority from Great Britain Application No. 2313600.5, filed Sep. 6, 2023, which application is incorporated herein by reference in its entirety.

### FIELD

The present invention relates to impedance matching in radio-frequency communications, particularly digital radio-frequency communications.

### BACKGROUND

Impedance matching is an important consideration in radio-frequency (RF) devices (e.g. transmitters, receivers and transceivers), since it is rarely the case the impedance of an antenna is matched to the impedance of radio circuitry within the device. In particular, an antenna is usually located off-chip (i.e. not as part of an integrated circuit) and the routing distance between the antenna itself and the integrated circuit is often of the same order of magnitude of a radio-frequency signal wavelength.

Complex conjugate impedance matching is important when it comes to power transfer of radio signals. This is the case for both transmission of RF signals via the antenna, and for reception of RF signals via the antenna. Poor impedance matching results in poor power transfer and noise profile, and good impedance matching results in better power transfer and noise profile. In order to improve performance, impedance matching networks located between an antenna and radio circuitry are often used to improve the impedance matching between the antenna and radio circuitry.

Impedance matching networks can be implemented as part of a silicon die (i.e. on-chip), or they can be implemented off-chip using e.g. surface mounted device (SMD) components. Impedance matching networks typically utilise a range of passive components (e.g. resistors, inductors, capacitors, etc.), although some use active components like transistors as well.

RF transceivers commonly use the same antenna(s) for transmission and for reception. This is particularly the case in half-duplex communications. RF transceivers commonly include a power amplifier for transmission of RF signals, and a low-noise amplifier for reception of RF signals. The Applicant has recognised however that sharing antennas requires a degree of compromise in selecting components for impedance matching between the requirements for transmission and reception.

The present invention aims to provide improvements in impedance matching in digital RF devices.

### SUMMARY OF THE INVENTION

When viewed from a first aspect, the invention provides a radio-frequency transceiver operable to transmit one or more radio-frequency signals via an antenna in a transmitter mode and to receive one or more radio-frequency signals via the antenna in a receiver mode, the transceiver comprising:
a power amplifier for use in the transmitter mode comprising a switched-capacitor array comprising a plurality of capacitance elements; and
a low-noise amplifier for use in the receiver mode;
   wherein the transceiver is configured, when operating in the receiver mode, to pull one or more of the capacitance elements in the switched-capacitor array to a ground potential.

When viewed from a second aspect, the invention provides a method of operating a radio-frequency transceiver, the method comprising:
in a transmitter mode, using a power amplifier comprising a switched-capacitor array comprising a plurality of capacitance elements to transmit one or more radio-frequency signals via an antenna; and
in a receiver mode:
   using a low-noise amplifier to receive one or more radio-frequency signals via the antenna; and
   pulling one or more of the capacitance elements in the switched-capacitor array to a ground potential.

The Applicant has recognised that by pulling one or more of the capacitance elements in the switched-capacitor array of the power amplifier to the ground potential when the transceiver is operating in the receiver mode, the transceiver may advantageously be able to modify the input impedance seen looking into the transceiver from the perspective of the antenna during reception compared to implementations without this functionality. As a result, embodiments of the present invention provide a convenient mechanism for improving impedance matching between the antenna and the low-noise amplifier, and thus improving the power transfer and noise profile between the antenna and the low-noise amplifier, by employing components normally only used during transmission without requiring additional components and area to provide this improved impedance matching. The present invention may thus advantageously provide this improved impedance matching without increasing overall size requirements of the transceiver and/or manufacturing costs.

In a set of embodiments, the transceiver further comprises an impedance matching network connected to the antenna, the same impedance matching network being used for transmission of radio-frequency signals using the power amplifier and for receipt of radio-frequency signals using the low-noise amplifier.

By sharing the same impedance matching network for the power amplifier during transmission and the low-noise amplifier during reception, the area and/or number of components required to provide suitable impedance matching between the power amplifier and the antenna, and between the antenna and the low-noise amplifier may be advantageously reduced. This may advantageously further reduce size requirements for the transceiver as well as reduce manufacturing costs.

By pulling one or more of the capacitance element(s) in the switched-capacitor array of the power amplifier to ground while the transceiver is operating in the receiver mode in accordance with the invention, the transceiver may alleviate drawbacks associated with previous arrangements where the impedance matching required for optimal power transfer between the power amplifier and the antenna is not the same as that required for optimal power transfer and noise profile between the antenna and the low-noise amplifier. This is because an additional degree of freedom can be provided for controlling the impedance matching between the antenna and the low-noise amplifier during reception. For example, the impedance matching network may be designed for optimal impedance matching between the power amplifier and the antenna and the one more capacitance elements pulled to the ground potential during reception may compensate for this.

The terms “connected” and “coupled”, as used herein are used to describe a direct connection or an indirect connection through any number of other active or passive components dependent on configuration. The impedance matching network may be connected between the power amplifier and the antenna, and it may be connected between the antenna and the low-noise amplifier.

In a set of embodiments the power amplifier is a single-ended power amplifier comprising a single output terminal connected to the antenna, and the low-noise amplifier is a single-ended low-noise amplifier comprising a single input terminal connected to the antenna.

In another set of embodiments, the power amplifier is a differential power amplifier comprising a first output terminal and a second output terminal, the power amplifier being configured to output a differential radio-frequency signal across the first and second output terminals. In such embodiments the switched-capacitor array may comprise a first switched-capacitor array portion connected to the first output terminal and a second switched-capacitor array portion connected to the second output terminal.

In a set of embodiments, the transceiver further comprises a balun arranged, when the transceiver is operating in the transmitter mode, to receive a differential signal output by the power amplifier and to output a single-ended signal to the antenna. The balun may also be arranged to receive a single-ended radio-frequency signal from the antenna and to output at least one side of a differential radio-frequency signal to the low-noise amplifier. The balun, in conjunction with the impedance matching network, may also serve to convert a square-wave radio-frequency signal output by the power amplifier to a closer-to-sinusoidal radio-frequency signal suitable for transmission through the antenna.

In a set of embodiments, the balun comprises:
a power-amplifier-side winding having a first terminal connected to a first output terminal of the power amplifier, and a second terminal connected to a second output terminal of the power amplifier;
   an antenna-side winding having a first terminal connected to the antenna, and a second terminal connected to ground. Such a configuration may help provide the differential to single-ended signal conversion functionality described above.

In a set of embodiments, the low-noise amplifier is a single-ended low-noise amplifier comprising a single input terminal connected to:
the first terminal of the antenna-side winding of the balun;
the first terminal of the power-amplifier-side winding of the balun; or
the second terminal of the power-amplifier-side winding of the balun.

In a set of embodiments, the low-noise amplifier is a differential low-noise amplifier comprising a first input terminal and a second input terminal, said first input terminal being connected to the first terminal of the antenna-side winding of the balun, and said second input terminal being connected to the second terminal of the power-amplifier-side winding of the balun. Such a configuration may advantageously improve the power transfer and/or noise profile for the low-noise amplifier on reception by effectively using the balun to convert a single-ended RF signal received at the antenna to a differential signal received at the low-noise amplifier. Alternatively, the first input terminal of the low-noise amplifier may be connected to the first terminal of the power-amplifier-side winding of the balun, and the second input terminal of the low-noise amplifier may be connected to the second terminal of the power-amplifier-side winding of the balun.

In a set of embodiments, the transceiver further comprises a pad cell connected between the antenna and the balun, the pad cell comprising electrostatic-discharge protection circuitry. This may advantageously enable the transceiver to protect one or more on-chip components therein from damage which may be caused by electrostatic energy received through the antenna or otherwise into the chip.

In a set of embodiments, each of the capacitance elements of the switched-capacitor array is switchably connectable to the ground potential via one or more transistors. The transistors may be MOSFETs, BJTs, or any other appropriate type of transistor. Each capacitance element may comprise a capacitor. The use of one or more transistors may provide a convenient and rapidly configurable mechanism for pulling the one or more capacitance elements in the switched-capacitor array to the ground potential when operating in the receiver mode.

In a set of embodiments, the switched-capacitor array comprises, for each capacitance element, a first transistor having: a first terminal connected to the capacitance element; a second terminal connected to the ground potential; and a control terminal which receives a respective control signal. The transceiver may be arranged to pull the one or more capacitance elements to the ground potential when operating in the receiver mode by controlling the control signals associated with said one or more capacitance elements so as to form a connection between said one or more capacitance elements and the ground potential via the associated first transistor. This may be done by controlling the respective control signal received by the first transistor to a value which allows current to flow between the first and second terminals—thereby allowing current to flow from the respective capacitance element to the ground potential and vice versa. Thus, each capacitance element may be pulled to the ground potential when the respective control signal is a logical ‘1’ or HIGH, e.g. equal to a positive supply voltage level, and floating when the respective control signal is a logical ‘0’ or LOW, e.g. equal to the ground potential.

In a set of embodiments, the switch-capacitor array further comprises, for each capacitance element, a second transistor having: a first terminal connected to the capacitance element and to the first terminal of the respective first transistor; a second terminal connected to a configurable supply voltage; and a control terminal which receives the respective control signal.

The first terminals of the first and/or second transistors may be drain terminals, the second terminals of the first and/or second transistors may be source terminals, and the control terminals of the first and/or second transistors may be gate terminals, e.g. where the first and/or second transistors comprise MOSFETs. The first transistor may comprise an NMOS transistor, and the second transistor may comprise a PMOS transistors. Each pair of first NMOS transistor and second PMOS transistor associated with each capacitance element may be connected in an inverter configuration, with the input of the inverter configuration being connected to the respective control signal and the output of the inverter configuration being connected to the respective capacitance element.

In a set of embodiments, the transceiver is arranged to:
pull the configurable supply voltage provided to the second terminals of the second transistors to the ground potential when operating in the receiver mode; and
pull the configurable supply voltage provided to the second terminals of the second transistors to a positive supply voltage when operating in the transmitter mode. The transceiver may therefore effectively prevent the power amplifier from outputting potentially interfering signals when operating in the receiver mode, while retaining the ability to pull one or more of the capacitance elements in the switched-capacitor array to the ground potential.

In a set of embodiments, the control signals provided to the control terminals of the first and second transistors are independently controllable from the configurable power supply. In such embodiments the transceiver may advantageously be able to control the configurable supply voltage independently from the control signals, thus allowing the impedance matching during reception to be improved by pulling one or more of the capacitance elements to the ground potential without causing the power amplifier to output any interfering signals. Each of the control signals may also be independently controllable by the transceiver from each other control signal. In a set of embodiments, the transceiver, when operating in the transmitter mode, is configured to repeatedly alternate the control signals provided to the first and second transistors associated with one or more of the capacitance elements in the switched-capacitor network so as to alternate between pulling those one or more capacitance elements to the ground potential via the associated first transistor(s) and pulling those one or more capacitance elements to the positive or negative supply voltage via the associated second transistor(s), in order to generate a radio-frequency square-wave signal. This may provide a convenient mechanism for the transceiver to control the amplitude of signals output by the power amplifier (and therefore those transmitted by the antenna) to a desired value by changing the number of capacitance elements used during transmission e.g. in order to reduce overall power consumption and thus save battery life where the transceiver is battery-powered.

The transceiver may be configured to repeatedly alternate the control signals provided to the first and second transistors associated with a subset of the capacitance elements in the switched-capacitor array, the subset of the capacitance elements being determined based on a control word received by the power amplifier. In such embodiments, when operating in the receiver mode, the transceiver may instead maintain the control signal provided to the control terminals of the transistors associated with each capacitance element at the same potential unvarying—i.e. not alternating the control signals repeatedly as done when operating in the transmitter mode.

In a set of embodiments, the transceiver, when operating in the receiver mode, is arranged to output a control word comprising a predetermined number of bits to the power amplifier, the number of capacitance elements being pulled to the ground potential when the transceiver is operating in the receiver mode being dependent on said control word. Each bit of the binary control word could be used as the respective control signal for each capacitance element of the switched-capacitor array, received by the control terminal(s) of the respective transistor(s) connected thereto, though in a set of preferred embodiments the control word is a binary control word and the power amplifier comprises a binary-to-thermometer converter which converts the control word to a thermometer-coded value, the control signals output to the control terminal(s) of the transistor(s) associated with each capacitance element being determined based on the value of each bit of the thermometer-coded value. This may provide a convenient mechanism for the transceiver to control the number of capacitance elements in the switched-capacitor array which are pulled to the ground potential when operating in the receiver mode.

In a set of embodiments, the transceiver is operable in a calibration phase in which it is arranged to operate in the receiver mode and to:
receive one or more radio-frequency signals at the antenna;
perform a sweep of the control word and, based on one or more signals output by the low-noise amplifier during the sweep, estimate one or more of a power gain, signal-to-noise ratio, and/or input reflection coefficient for each value of the control word; and
determine an optimal value of the control word for use when the transceiver is operating in the receiver mode in an operation phase based on said estimated power gains, signal-to-noise ratios and/or input reflection coefficients.

When in the operation phase the transceiver may, when operating in the receiver mode, output the determined optimal value of the control word to the power amplifier. The optimal value of the control word may be stored in a non-volatile memory of the transceiver. Such embodiments may advantageously allow process variations across different devices to be accounted for by determining an optimal number of capacitance elements to be connected to ground for a specific device when operating in the receiver mode. This may provide the added advantage of improving foundry yield. The calibration phase may occur during production testing of the transceiver, and the operation phase may occur while the transceiver is in use post-testing e.g. by a user.

In an alternative set of embodiments, the transceiver is operable in a calibration phase in which it is arranged to operate in the receiver mode and to:
receive a plurality of radio-frequency signals received over a range of frequencies;
for each frequency of signal received:
   perform a sweep of the control word and, based on one or more signals output by the low-noise amplifier during the sweep, estimate one or more of a power gain, signal-to-noise ratio, and/or input reflection coefficient for each value of the control word;
   determine an optimal value of the control word for use when the transceiver is operating in the receiver mode in an operation phase for that frequency based on said estimated power gains, signal-to-noise ratios and/or input reflection coefficients; and
store, in a non-volatile memory, a lookup table comprising the determined optimal value of the control word determined for each frequency of signal received.

When in the operation phase the transceiver may, when operating in the receiver mode:
determine the frequency of a received signal;
retrieve from the lookup table stored in the non-volatile memory an optimal value of the control word for the determined frequency; and
output the determined optimal value of the control word to the power amplifier.

Such embodiments may advantageously allow the transceiver to dynamically configure the number of capacitance elements pulled to the ground potential when operating in the receiver mode in dependence on received signal frequency, in order to improve impedance matching (and thus power transfer and/or noise profile), which is dependent on frequency, over a range of received frequencies. This may be particularly advantageous where the transceiver is configured to receive signals over a large frequency range.

The transceiver may comprise an integrated circuit (e.g. a system-on-chip) comprising the power amplifier and the low-noise amplifier. The impedance matching network may comprise an off-chip impedance matching network implemented using one or more passive surface mounted device (SMD) components. Alternatively, the impedance matching network may be implemented on-chip using integrated passive components on the integrated circuit. The transceiver may comprise a processor and a computer-readable storage medium (e.g. a non-volatile memory) comprising instructions which, when executed by the processor, cause the transceiver to perform any of the above-mentioned functions.

Features of any aspect or embodiment described herein may, wherever appropriate, be applied to any other aspect or embodiment described herein. For example, features described above or below in relation to the radio-frequency transceiver of the first aspect should be considered to equally apply to the method of the second aspect, and vice versa. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings in which:

FIG. 1 is a schematic diagram illustrating the operating principles of a switched-capacitor array for use in a power amplifier of a radio-frequency transceiver;

FIG. 2 is a schematic diagram of a transceiver in accordance with an embodiment of the present invention;

FIG. 3 is a graph illustrating an input resistance and input reactance (combined giving the input impedance) seen looking into the transceiver against the number of capacitance elements in the switched-capacitor array pulled to a ground potential during reception;

FIG. 4 is a graph illustrating a voltage gain and noise figure of a low-noise amplifier against a number of capacitance elements in the switched-capacitor array pulled to the ground potential during reception; and

FIG. 5 is a flowchart showing a simplified process flow for a transceiver in accordance with an embodiment of the present invention.

### DETAILED DESCRIPTION OF THE DRAWINGS

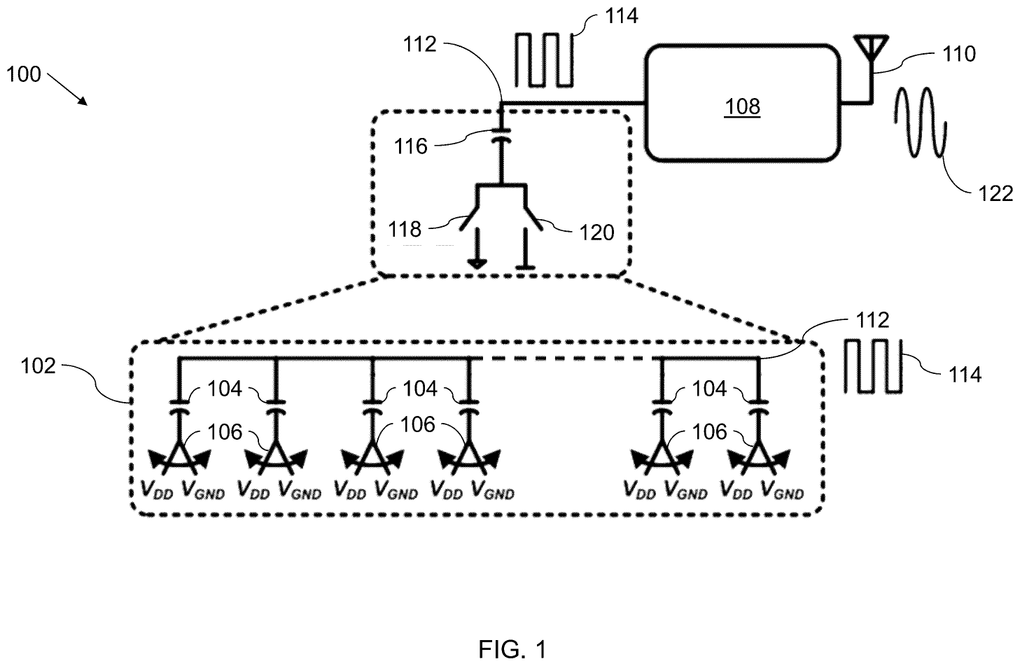

FIG. 1 is a schematic diagram illustrating the operating principles of a switched-capacitor array 102 for use in a power amplifier of a radio-frequency transceiver 100. The switched-capacitor array 102 comprises a plurality of capacitance elements 104, in this case each capacitance element being a capacitor, each having an associated alternating switch 106. Each switch 106 enables the associated capacitance element 104 to be pulled to the ground potential V_{GND}, or to the supply voltage potential V_{DD}. The transceiver 100 also comprises an impedance matching network 108 and an antenna 110. Although only six capacitance elements 104 and associated switches 106 are shown here, it will be appreciated that the principles outlined herein equally apply to any number of capacitance elements 104 and associated switches 106.

When the transceiver 100 is transmitting a radio-frequency signal, it repeatedly alternates the switches 106 associated with one or more of the capacitance elements 104 in order to pull the respective capacitance element 104 to the ground potential V_{GND}, or to the supply voltage potential V_{DD}, at a desired frequency. The transceiver 100 can select how many of the capacitance elements 104 and associated switches 106 to do this with depending on the desired amplitude of the transmitted radio-frequency signal. The more capacitance elements 104 used, the larger the amplitude of the transmitted radio-frequency signal. In this case, for simplicity, all of the capacitance elements 104 are shown to be used by the transceiver 100 for signal transmission.

As a result of this switching connection of the switches 106 between the supply voltage V_{DD} and ground, the resulting voltage at the node 112 connecting the capacitance elements 104 is a close-to-square wave 114 having a fundamental frequency equal to the frequency of switching of the switches 106. The amplitude of this square wave 114 is dependent on the number of capacitance elements 104 and associated switches 106 used, as well as the supply voltage V_{DD} provided to the switches 106.

The entire switched capacitor array 102 can therefore be shown in a simplified form as a single variable capacitor 116 connected to two alternating switches: a first switch 118 connected to the supply voltage potential V_{DD} and a second switch 120 connected to the ground potential V_{GND}. The two switches switch in unison in order to generate the square wave 114 at the node 112.

The square wave 114 at the node 112 is output to the impedance matching network 108, which includes various passive components for impedance-matching between the switched-capacitor array 102 and the antenna 110, as well as filtering the square wave 114 into a more sinusoidal wave 122 for transmission via the antenna 110.

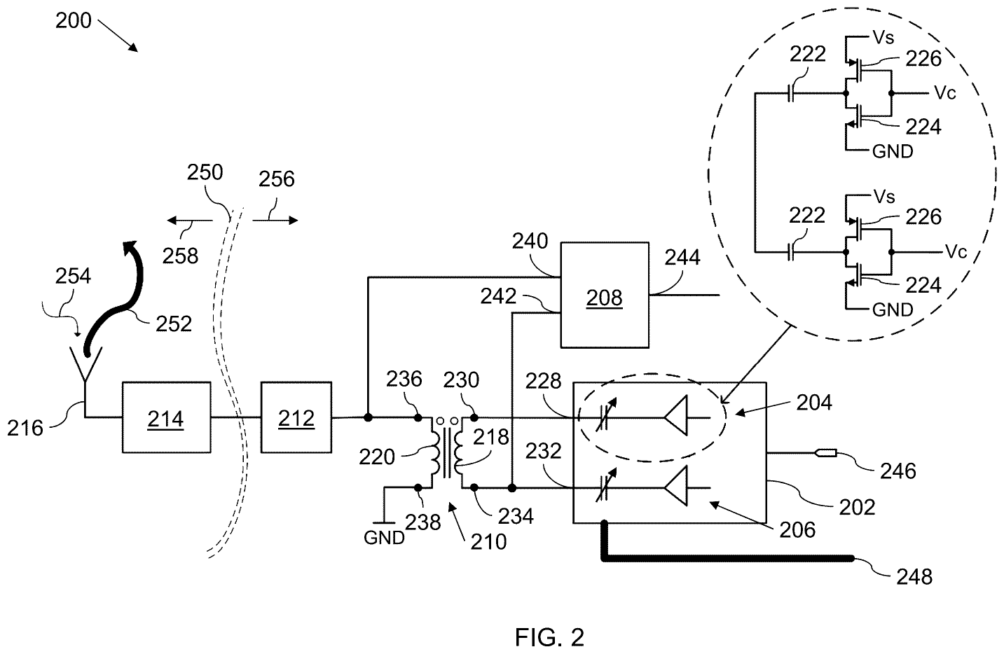

FIG. 2 is a schematic diagram of a transceiver 200 in accordance with an embodiment of the present invention. The transceiver 200 comprises a differential power amplifier 202 comprising a first switched-capacitor array 204 portion and a second switched-capacitor array 206 portion (which can be together considered as a single combined switched-capacitor array for the purpose of radio-frequency signal reception, as is set out in more detail below), a low-noise amplifier 208, a balun 210, a pad cell 212, an impedance matching network 214 and an antenna 216. The balun 210 comprises a power-amplifier-side winding 218 and an antenna-side winding 220.

The first switched-capacitor array 204 portion comprises a plurality of capacitance elements 222, although only two capacitance elements 222 are shown in FIG. 2 for the sake of simplicity—there may of course be any number of capacitance elements 222 dependent upon configuration. The second switched-capacitor array portion 206 has an identical structure and very similar function to the first switched-capacitor array portion 204, and therefore is not discussed in detail herein for the sake of brevity.

Each capacitance element 222 is connected to the respective drain terminal of a first (NMOS) transistor 224, and the drain terminal of a second (PMOS) transistor 226. The source terminal of each first transistor 224 is connected to ground GND, and the source terminal of each second transistor 226 is connected to a configurable supply voltage Vs which is configurable dependent on the mode of operation of the transceiver 200 as explained in more detail below. The control (gate) terminals of each of the first and second transistors 224, 226 are coupled to control circuitry (not shown) which outputs a respective configurable control signal Vc for each pair of transistors 224, 226. It will be seen therefore that the first and second transistors 224, 226 are connected in an inverter configuration, with the input of the inverter being the control signal Vc and the output of the inverter being connected to the respective capacitance element 222.

For symmetry on both sides of the differential output of the power amplifier 202, both switched-capacitor array portions 204, 206 have the same number of capacitance elements 222 and associated transistors 224, 226. This could be any appropriate number depending on implementation (e.g. sixteen, thirty-two, sixty-four, etc.).

The first switched-capacitor array portion 204 provides a first output terminal 228 of the power amplifier 202, and the second switched-capacitor array portion 206 provides a second output terminal 232 of the power amplifier 202. The first output terminal 228 of the power amplifier 202 is connected to a first terminal 230 of the power-amplifier-side winding 218 of the balun 210, and the second output terminal 232 of the power amplifier 202 is connected to a second terminal 234 of the power-amplifier-side winding 218 of the balun 210. A first terminal 236 of the antenna-side winding 220 of the balun 210 is connected to the pad cell 212, and a second terminal 238 of the antenna-side winding 220 of the balun 210 is connected to ground. A first input terminal 240 of the low-noise amplifier 208 is connected to the first terminal 236 of the antenna-side winding 220 of the balun 210, and a second input terminal 242 of the low-noise amplifier 208 is connected to the second terminal 234 of the power-amplifier-side winding 218 of the balun 210.

The low-noise amplifier 208 comprises an output terminal 244 which outputs amplified received signals to further receiver circuitry (e.g. radio-frequency mixer, decoders, demodulators, filters, etc.) not shown in FIG. 2 for the sake of simplicity. Similarly, the power amplifier 202 receives signals from other transmitter circuitry (e.g. radio-frequency phase locked loop, modulators, encoders, filters, etc.) not shown in FIG. 2 for the sake of simplicity. The power amplifier 202 also comprises a power supply control line 246 which receives control signals from other circuitry not shown in FIG. 2 for the sake of simplicity, and a switched-capacitor activation control line 248 which also receives control signals from other circuitry not shown in FIG. 2 for the sake of simplicity.

The pad cell 212 is connected between the first terminal 236 of the antenna-side winding 220 of the balun 210 and the impedance matching network 214, and the impedance matching network 214 is connected between the pad cell 212 and the antenna 216. The line 250 indicates the effective boundary between on-chip (i.e. forming part an integrated circuit 256—e.g. a system-on-chip) and off-chip components 258 of the transceiver 200. Components to the left side 258 of the line 250 are implemented off-chip, e.g. using surface-mounted device (SMD) components, and components to the right side 256 of the line 250 are implemented on-chip.

While in this particular embodiment the first input terminal 240 of the low-noise amplifier 208 is connected to the first terminal 236 of the antenna-side winding 220 of the balun 210, this could instead be connected to the first terminal 230 of the power-amplifier-side winding 218 of the balun 210 (thus taking a differential input from the two terminals 230, 234 of the power-amplifier-side winding 218). Also, while in this particular embodiment the low-noise amplifier 208 is a differential low-noise amplifier with two input terminals 240, 242, in other embodiments it could be a single-ended low-noise amplifier with only one input terminal. In such embodiments the single input terminal of the low-noise amplifier 208 could be connected to the first terminal 236 of the antenna-side winding 220 of the balun 210, to the first terminal 230 of the power-amplifier-side winding 218 of the balun 210, or to the second terminal 234 of the power-amplifier-side winding 218 of the balun 210.

Furthermore, while in this particular embodiment both the power amplifier 202 and the low-noise amplifier 208 are differential, these could both be single-ended in other embodiments. In such embodiments the balun 210 could be omitted, the single output terminal of the power amplifier 202 and the single input terminal of the low-noise amplifier 208 could both be connected directly to the pad cell 212.

The operation of the transceiver 200 will now be described in detail. The transceiver 200 illustrated in FIG. 2 is a half-duplex transceiver operable in a transmitter mode and a receiver mode. When operating in the transmitter mode, the low-noise amplifier 208 is disabled, and the power amplifier 202 is enabled and used to transmit outgoing radio-frequency signals 252 via the antenna 216. When operating in the transmitter mode, the power amplifier 202 receives a signal over the power supply control line 246 which causes the power amplifier 202 to provide a positive supply voltage Vs to the source terminals of the second transistors 226 in the first switched capacitor array portion 204. The number of capacitance elements 222 and associated transistors 224, 226 used in each of the switched-capacitor arrays 204, 206 during transmission is configured in dependence on a binary control word received over the switched-capacitor activation control line 248.

In this example, the power amplifier 202 comprises a binary-to-thermometer converter, as well as other logical circuitry, to configure how many of the capacitance elements 222 and the associated transistors 224, 226 are used for signal transmission in both switched-capacitor array portions 204, 206. In this particular embodiment, the number of capacitance elements 222 which are used for signal transmission in both switched-capacitor arrays 204, 206 is proportional to the decimal value of the binary control word received over the switched-capacitor activation control line 248. For symmetry on both sides of the differential output of the power amplifier 202, the same number of capacitance elements 222 are used for signal transmission in both switched-capacitor array portions 204, 206, and this is based on the value of the binary control word received over the switched-capacitor activation control line 248, though it will be appreciated that this need not be the case in other embodiments.

When a respective control voltage Vc is a logical ‘1’ (HIGH), the first (NMOS) transistor 224 is conducting, and the second (PMOS) transistor 226 is non-conducting. Thus, the respective capacitance element 222 is pulled to the ground potential GND. When a respective control voltage Vc is a logical ‘0’ (LOW), the first (NMOS) transistor 224 is non-conducting, and the second (PMOS) transistor 226 is conducting. Thus, the respective capacitance element 222 is pulled to the supply voltage potential Vs. It will thus be appreciated that each pair of transistors 224, 226 functions in much the same manner as each of the switches 106 described above with reference to FIG. 1, with the control signals with the power amplifier 202 alternating the control signals Vc provided to the gate terminals of the first and second transistors 224, 226 between a logical ‘0’ (LOW) and a logical ‘1’ (HIGH) at a radio frequency.

The operation of the second switched-capacitor array portion 206 during transmission is much the same as that of the first switched-capacitor array 204 described above, with the source terminals of the first (NMOS) transistors 224 being connected to ground and the source terminals of the second (PMOS) transistors 226 being connected to the supply voltage potential. However, the control signals Vc provided to the gate terminals of the first and second transistors 224, 226 in the second switched-capacitor array portion 206 are inverted relative to the corresponding control signals Vc provided to the first switched-capacitor array portion 204 so as to cause the second switched-capacitor array portion 206 to output a square wave signal which is inverted relative to the signal output by the first switched-capacitor array portion 204 (thus forming a differential output signal across the two output terminals 228, 232 of the power amplifier 202).

Thus, during transmission, the power amplifier 202 outputs a first side of a differential output square-wave signal from its first output terminal 228 to the first terminal 230 of the power-amplifier-side winding 218 of the balun 210, and a second side of the differential output square-wave signal from its second output terminal 232 to the second terminal 234 of the power-amplifier-side winding 218 of the balun 210. The winding 210 then converts this differential signal to a single-ended signal at the antenna-side winding 220, which it outputs to the pad cell 212. The signal propagates through the pad cell 212 to the impedance matching network 214.

The balun 210, in combination with the impedance matching network 214, also converts this square-wave signal into a more sinusoidal signal suitable for transmission via the antenna 216, since this combination contains one or more resistors, inductors and/or capacitors which perform this function. The antenna 216 receives this signal from the impedance matching network 214 and transmits the outgoing radio-frequency signal 252. The impedance matching network 214 also serves to provide impedance matching between the power amplifier 202 and the antenna 216, in order to provide improved power transfer and noise profile for radio-frequency signal transmission and avoid losses due to poor impedance matching between the power amplifier 202 and antenna 216 (e.g. due to signal reflection, etc.). The impedance matching network 214 comprises one or more passive components which provide this functionality, as is known in the art. In this example, the impedance matching network 214 is optimised for the power amplifier 202—i.e. it is designed to provide optimal impedance matching between the power amplifier 202 and the antenna 216.

When the transceiver 200 is operating in the receiver mode, the low-noise amplifier 208 is enabled, and the power amplifier 202 is disabled (to an extent, as described in more detail below). An incoming radio-frequency signal 254 is received at the antenna 216. This signal propagates through the same impedance matching network 214, and the pad cell 212, to the first input terminal 240 of the low-noise amplifier 208. The pad cell 212 contains electrostatic discharge protection circuitry which helps prevent damage to the components on the chip in the event of a burst of electrostatic energy being received at the antenna or otherwise into the integrated circuit 256.

The incoming signal 254 is also received at the first terminal 236 of the antenna-side winding of the balun 210, which then effectively converts this signal to a pair of differential signals in the power-amplifier-side winding 218. One side of this differential signal is then received by the second input terminal 242 of the low-noise amplifier 208, effectively forming a differential signal across the two input terminals 240, 242 of the low-noise amplifier 208. The low-noise amplifier 208 then amplifies and converts this differential signal back into a single-ended signal, adding as little noise as possible, and outputs this to further receiver circuitry (not shown) via its output terminal 244.

The impedance matching circuit 214 also provides impedance matching between the antenna 216 and the low-noise amplifier 208. However, the optimal impedance matching for the low-noise amplifier 208 is not the same as it is for the power amplifier 202, since these contain different components and therefore have different impedances.

In order to counteract this, when operating in the receiver mode, the transceiver 200 utilises the switched-capacitor arrays 204, 206 in order to improve impedance matching between the antenna 216 and the low-noise amplifier 208. During reception, the transceiver 200 provides a power supply control signal to the power amplifier 202 via the power supply control line 246 which causes it to pull the supply voltage Vs provided to the source terminals of the second transistors 226 to the ground potential. This prevents the power amplifier 202 outputting any signals to the balun 210, since no power is supplied to the capacitance elements 222 regardless of the configuration of the control signals Vc. This prevents any interference being received from the power amplifier 202 during reception by the low-noise amplifier 208.

In this example, however, the control signals Vc provided to the first and second transistors 224, 226 in the switched-capacitor arrays 204, 206 remain controllable by the transceiver 200 when it is operating in the receiver mode, by inputting a binary control word to the power amplifier 202 via the switched-capacitor activation control line 248. This is controlled independently of the power supply control line 246.

When a control signal received by a given transistor pair 224, 226 is HIGH, the first (NMOS) transistor 224 is conducting, and the second (PMOS) transistor 226 is non-conducting. The associated capacitance element 222 is therefore pulled to the ground potential via the first transistor 224. When a control signal received by a given transistor pair 224, 226 is LOW, the first (NMOS) transistor 224 is non-conducting (since its gate-source voltage is below the threshold voltage), and the second (PMOS) transistor 226 is also non-conducting (since its gate-source voltage is above the threshold voltage since the source voltage of the transistor 226 is zero as it is connected to the ground potential in the receiver mode). The associated capacitance element 222 is therefore left floating (i.e. it has a very high impedance seen looking into the chip 256 from the perspective of the antenna 216). Thus, the transceiver 200 is able to select whether to pull a given capacitance element 222 to the ground potential by providing a HIGH control voltage Vc to the associated transistor pair 224, 226, or whether to leave a given capacitance element 222 floating by providing a LOW control voltage Vc to the associated transistor pair 224, 226.

Thus, when the transceiver 200 is operating in the receiver mode, it pulls one or more of the capacitance elements 222 to the ground potential (the number being dependent on the binary control word received over the switched-capacitor activation control line 248). The number of capacitance elements 222 which are pulled to the ground potential in this manner changes the input impedance seen from the antenna's perspective looking in to the transceiver 200. This therefore provides a second degree of freedom for tuning the impedance matching between the antenna 216 and the low-noise amplifier 208, in addition to the impedance matching network 214, which can be used to provide closer-to-optimal power transfer and noise profile for the low-noise amplifier 208. In this particular example, the same number of capacitance elements 222 are pulled to the ground potential in each of the first and second switched-capacitor array portions 204, 206 when the transceiver 200 is operating in the receiver mode due to the symmetric response of the power amplifier 202 to the binary control word received over the switched-capacitor activation control line 248. It will be appreciated, however, that this does not need to be the case and that in other embodiments different numbers of capacitance elements 222 in the two switched-capacitor array portions 204, 206 could be pulled to ground when the transceiver 200 operating in the receiver mode.

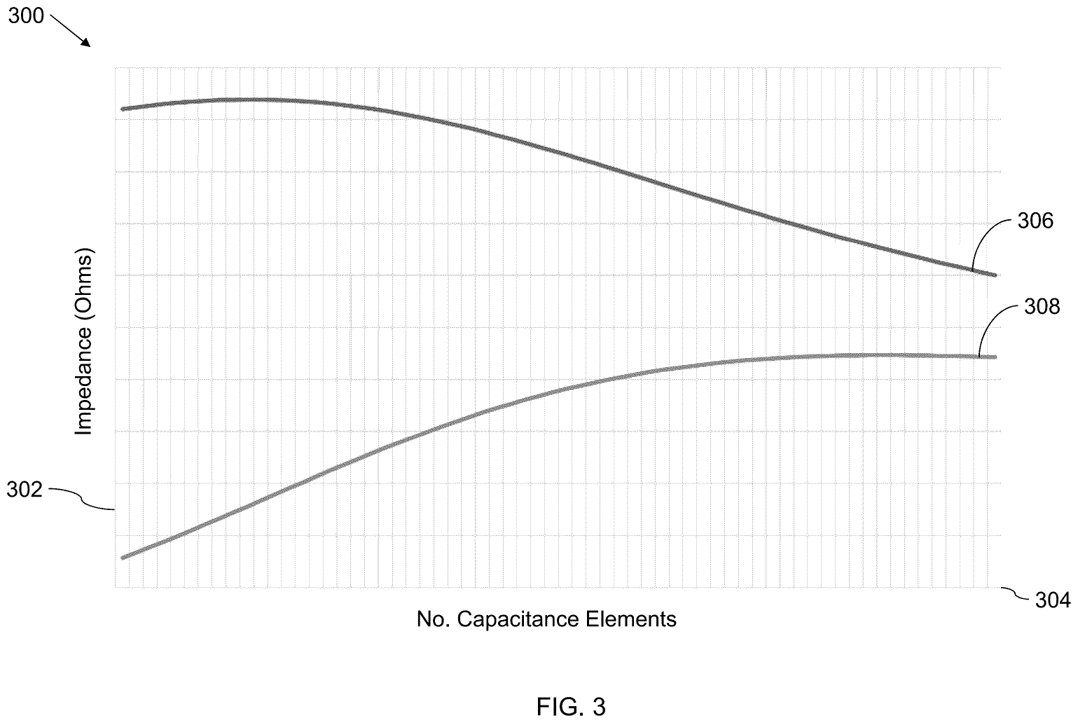

FIG. 3 is a graph 300 illustrating the input resistance and input reactance (combined giving the input impedance) seen looking into the transceiver 200 from the perspective of the antenna 216 against the number of capacitance elements 222 in the switched-capacitor arrays 204, 206 of the power amplifier 202 pulled to the ground potential when the transceiver is operating in the receiver mode. The vertical axis 302 indicates the input impedance (resistance/reactance) in Ohms, and the horizontal axis 304 indicates the number of capacitance elements 222 pulled to the ground potential (which is proportional to the decimal value of the binary control word received by the power amplifier 202 over the switched-capacitor activation control line 248). The upper line 306 shows the input resistance from the perspective of the antenna seen looking into the transceiver 200 when operating in the receiver mode, and the lower line 308 shows the input reactance from the perspective of the antenna 216 seen looking into the transceiver 200 when operating in the receiver mode.

It can be seen from FIG. 3 that, in this particular example, the input resistance 306 and the input reactance 308 change as the number of capacitance elements 222 pulled to the ground potential when the transceiver 200 is operating in the receiver mode changes. Thus it will be appreciated from FIG. 3 that pulling a desired number of the capacitance elements 222 to the ground potential in the receiver mode can alter the input impedance seen from the perspective of the antenna 216, and thus provide a second degree of freedom for controlling the impedance matching between the antenna 216 and the low-noise amplifier 208 for better overall performance during reception.

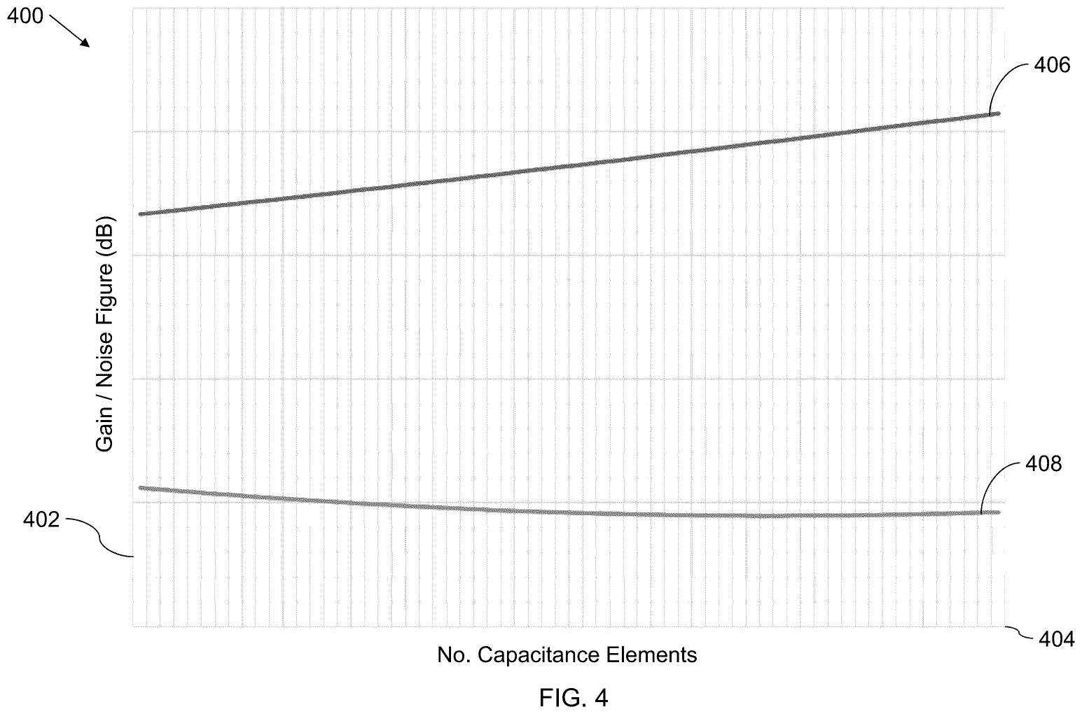

FIG. 4 is a graph 400 illustrating the voltage gain and noise figure of the low-noise amplifier 208 against the number of capacitance elements 222 in the switched-capacitor arrays 204, 206 of the power amplifier 202 pulled to the ground potential when the transceiver 200 is operating in the receiver mode. The vertical axis 402 indicates the voltage gain/noise profile in decibels, and the horizontal axis 404 indicates the number of capacitance elements 222 pulled to the ground potential. The upper line 406 shows the voltage gain at the output 244 of the low-noise amplifier 208, and the lower line 408 shows the noise figure at the output 244 of the low-noise amplifier 208.

It can be seen from FIG. 4 that, in this particular example, as the number of capacitance elements 222 in the switched-capacitor arrays 204, 206 pulled to the ground potential increases, the voltage gain 406 generally increases and the noise figure 408 generally decreases. This occurs due to the improved impedance matching between the antenna 216 and the low-noise amplifier 208 which occurs as a result of pulling these capacitance elements 222 to the ground potential.

Although the graph 400 shown in FIG. 4 indicates that better receiver performance (e.g. signal-to-noise ratio) is obtained when a greater number of capacitance elements 222 in the power amplifier 202 are pulled to the ground potential during reception, this may not be the case depending on the specific architecture of the transceiver 200 (e.g. the components used in the impedance matching network 214, the number of capacitance elements 222 available in each of the switched-capacitor arrays 204, 206, etc.) as well as process variations between transceivers 200 having the same architecture.

Thus, referring again to FIG. 2, during a calibration phase of the transceiver 200 (e.g. during production testing, before shipping to customers), the transceiver 200 performs a sweep of the binary control word received over the switched-capacitor activation control line 248 during receipt of a test signal 254, and measures signals output by the low-noise amplifier 208, and based on those signals estimates one or more of a power gain, signal-to-noise ratio, and/or input reflection coefficient. From these signals, it is possible for the transceiver 200 to determine an optimal value of the control word to use when the transceiver 200 is operating in the receiver mode—e.g. the control word which maximises power gain and/or signal-to-noise ratio, or the control word which minimises the input reflection coefficient. The transceiver 200 then, during an operation phase (e.g. while in use by a user) outputs the determined optimal value of the control word to the power amplifier 202 while operating in the receiver mode in order to provide optimal overall receiver performance specific to the device.

The transceiver 200 in this particular example comprises a processor and a non-volatile memory (not shown in FIG. 2) for this purpose—the optimal value of the control word is stored in the non-volatile memory after its determination during the calibration phase and output by the processor to the power amplifier 202 during the operation phase. This mechanism is simple and particularly effective for transceivers 200 which operate over a relatively narrow range of frequencies—e.g. Bluetooth™ devices.

In another embodiment, during the calibration phase of the transceiver 200, it receives a plurality of test signals 254 over a range of frequencies, and performs the control word sweep and determination of an optimal control word described above for each frequency of test signal received. In this embodiment, the transceiver 200 stores the optimal control words in a lookup table in the non-volatile memory against the incoming radio frequency. Then, when the transceiver 200 is operating in the operation mode, it detects the frequency of an incoming radio-frequency signal 254 and determines the optimal control word to provide to the power amplifier 202 for that frequency using the lookup table. This mechanism is particularly suitable for transceivers 200 which operate over a relatively large range of frequencies.

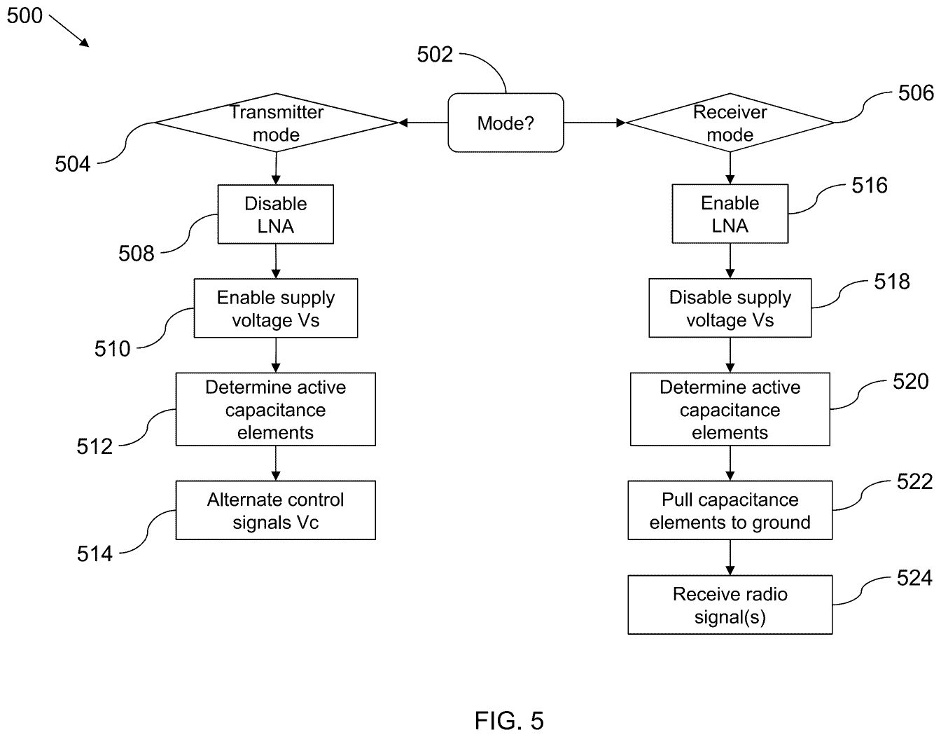

FIG. 5 is a flowchart showing a simplified process flow 500 for the transceiver 200. At step 502, the transceiver 200 determines which mode of operation it is in. If it is in the transmitter mode 504, it proceeds to step 508. If it is in the receiver mode 506, it proceeds to step 516.

At step 508, after determining that it is operating in the transmitter mode 504, the transceiver 200 disables the low-noise amplifier 208. At step 510, the transceiver 200 enables the supply voltage Vs provided to the source terminals of the second transistors 226—i.e. it provides a positive or negative supply voltage Vs thereto in dependence on whether the transistor 226 forms part of the first switched-capacitor array 204 portion or the second switched-capacitor array 206 portion. At step 512, the transceiver 200 provides a control word to the power amplifier 202 over the switched-capacitor activation line 248 from which the power amplifier 202 determines which capacitance elements 222 should be used for signal transmission. At step 514, the power amplifier 202 alternates the control signals Vc provided to the transistors 224, 226 associated with the capacitance elements 222 selected for signal transmission at step 512 in order to transmit one or more radio-frequency signals as described previously. The control signals Vc provided to the transistors associated with the capacitance elements 222 not selected for signal transmission at step 512 are instead held at a potential which forms a connection between said capacitance elements 22 and the ground potential GND via the first transistor 224, thereby effectively disabling those capacitance elements 222 in the switched-capacitor arrays 204, 206.

At step 516, after determining that it is operating in the receiver mode 506, the transceiver 200 enables the low-noise amplifier 208. At step 518, the transceiver 200 pulls the supply voltage Vs provided to the source terminals of the second transistors 226 to the ground potential GND. At step 520, the transceiver 200 provides a control word to the power amplifier 202 over the switched-capacitor activation line 248 from which the power amplifier 202 determines which capacitance elements 222 should be pulled to the ground potential during signal reception.

At step 522, the power amplifier 202 provides and maintains a control signal Vc to the transistors 224, 226 associated with each of the capacitance elements 222 selected in the previous step 520 which causes the respective first transistor to start conducting (as described previously) and thus forms a connection between these capacitance elements 222 and the ground potential GND via the respective first transistor 224, thereby pulling the capacitance elements 222 to the ground potential. The control signals Vc provided to the capacitance elements 222 not selected to be pulled to the ground potential during signal reception are instead maintained at a different potential which causes those capacitance elements 222 to remain floating, as described previously. At step 524, the receiver 200 receives one or more radio-frequency signals 254. The signal-to-noise ratio of these signals is improved by the enhanced impedance matching provided by pulling some or all of the capacitance elements 222 to ground.

It will be appreciated by those skilled in the art that the invention has been illustrated by describing one or more specific embodiments thereof, but it is not limited to these embodiments; many variations and modifications are possible, within the scope of the appended claims.

1. A radio-frequency transceiver operable to transmit one or more radio-frequency signals via an antenna in a transmitter mode and to receive one or more radio-frequency signals via the antenna in a receiver mode, the transceiver comprising:
a power amplifier for use in the transmitter mode comprising a switched-capacitor array comprising a plurality of capacitance elements; and
a low-noise amplifier for use in the receiver mode;
wherein the transceiver is configured, when operating in the receiver mode, to pull one or more of the capacitance elements in the switched-capacitor array to a ground potential.

2. The radio-frequency transceiver as claimed in claim 1 comprising an impedance matching network connected between the power amplifier and the antenna, and connected between the antenna and the low-noise amplifier.

3. The radio-frequency transceiver as claimed in claim 1, wherein:
the power amplifier is a single-ended power amplifier comprising a single output terminal connected to the antenna; and
the low-noise amplifier is a single-ended low-noise amplifier comprising a single input terminal connected to the antenna.

4. The radio-frequency transceiver as claimed claim 1, wherein the power amplifier is a differential power amplifier comprising a first output terminal and a second output terminal, the power amplifier being arranged to output a differential radio-frequency signal across the first and second output terminals.

5. The radio-frequency transceiver as claimed in claim 4, wherein the switched-capacitor array comprises a first switched-capacitor array portion connected to the first output terminal of the power amplifier and a second switched-capacitor array portion connected to the second output terminal of the power amplifier.

6. The radio-frequency transceiver as claimed in claim 4 further comprising a balun arranged, when the transceiver is operating in the transmitter mode, to receive a differential signal output by the power amplifier and to output a single-ended signal to the antenna.

7. The radio-frequency transceiver as claimed in claim 6, wherein the balun is arranged, when the transceiver is operating in the receiver mode, to receive a single-ended radio-frequency signal from the antenna and to output at least one side of a differential radio-frequency signal to the low-noise amplifier.

8. The radio-frequency transceiver as claimed in claim 6, wherein the balun comprises:
a power-amplifier-side winding having a first terminal connected to a first output terminal of the power amplifier, and a second terminal connected to a second output terminal of the power amplifier;
an antenna-side winding having a first terminal connected to the antenna, and a second terminal connected to the ground potential.

9. The radio-frequency transceiver as claimed in claim 8, wherein the low-noise amplifier is a single-ended low-noise amplifier comprising a single input terminal connected to:
the first terminal of the antenna-side winding of the balun;
the first terminal of the power-amplifier-side winding of the balun; or
the second terminal of the power-amplifier-side winding of the balun.

10. The radio-frequency transceiver as claimed in claim 8, wherein the low-noise amplifier is a differential low-noise amplifier comprising a first input terminal and a second input terminal, wherein:
said first input terminal is connected to the first terminal of the antenna-side winding of the balun, and said second input terminal is connected to the second terminal of the power-amplifier-side winding of the balun; or
said first input terminal is connected to the first terminal of the power-amplifier-side winding of the balun, and said second input terminal is connected to the second terminal of the power-amplifier-side winding of the balun.

11. The radio-frequency transceiver as claimed in claim 1, further comprising a pad cell connected between the antenna and the low-noise amplifier, the pad cell comprising electrostatic-discharge protection circuitry.

12. The radio-frequency transceiver as claimed in claim 1, wherein each of the capacitance elements of the switched-capacitor array is switchably connectable to the ground potential via one or more transistors.

13. The radio-frequency transceiver as claimed in claim 1, wherein:
the switched-capacitor array comprises, for each capacitance element, a first transistor having: a first terminal connected to the capacitance element; a second terminal connected to the ground potential; and a control terminal which receives a respective control signal; and
the transceiver is arranged to pull the one or more capacitance elements to the ground potential when operating in the receiver mode by controlling the control signals associated with said one or more capacitance elements so as to form a connection between said one or more capacitance elements and the ground potential via the associated first transistor.

14. The radio-frequency transceiver as claimed in claim 13, wherein the switch-capacitor array further comprises, for each capacitance element, a second transistor having: a first terminal connected to the capacitance element and to the first terminal of the respective first transistor; a second terminal connected to a configurable supply voltage; and a control terminal which receives the respective control signal.

15. The radio-frequency transceiver as claimed in claim 14, wherein each first transistor comprises an NMOS transistor, and each second transistor comprises a PMOS transistor.

16. The radio-frequency transceiver as claimed in claim 14, wherein the first transistor and the second transistor associated with each capacitance element are connected in an inverter configuration, with the input of the inverter configuration receiving the respective control signal and the output of the inverter configuration being connected to the respective capacitance element.

17. The radio-frequency transceiver as claimed in claim 14 arranged to:
pull the configurable supply voltage provided to the second terminals of the second transistors to the ground potential when operating in the receiver mode; and
pull the configurable supply voltage provided to the second terminals of the second transistors to a positive supply voltage when operating in the transmitter mode.

18. The radio-frequency transceiver as claimed in claim 14, wherein the control signals provided to the control terminals of the transistors associated with each capacitance element are independently controllable from the configurable power supply.

19. The radio-frequency transceiver as claimed in claim 14 configured, when operating in the transmitter mode, to repeatedly alternate the control signals provided to the first and second transistors associated with one or more of the capacitance elements in the switched-capacitor network so as to alternate between pulling said one or more capacitance elements to ground via the associated first transistor(s) and pulling said one or more capacitance elements to the positive or negative supply voltage potential via the associated second transistor (s), in order to generate a radio-frequency square-wave signal.

20. The radio-frequency transceiver as claimed in claim 1 arranged, when operating in the receiver mode, to output a control word comprising a predetermined number of bits to the power amplifier, the number of capacitance elements being pulled to the ground potential when the transceiver is operating in the receiver mode being dependent on said control word.

21. The radio-frequency transceiver as claimed in claim 20 operable in a calibration phase in which it is arranged to operate in the receiver mode and to:
receive one or more radio-frequency signals at the antenna;
perform a sweep of the control word and, based on one or more signals output by the low-noise amplifier during the sweep, estimate one or more of a power gain, signal-to-noise ratio, and/or input reflection coefficient for each value of the control word; and
determine an optimal value of the control word for use when the transceiver is operating in the receiver mode in an operation phase based on said estimated power gains, signal-to-noise ratios and/or input reflection coefficients.

22. The radio-frequency transceiver as claimed in claim 21 arranged in said operation phase, to output the determined optimal value of the control word to the power amplifier when operating in the receiver mode.

23. The radio-frequency transceiver as claimed in claim 20 operable in a calibration phase in which it is arranged to operate in the receiver mode and to:
receive a plurality of radio-frequency signals received over a range of frequencies;
for each frequency of signal received:
perform a sweep of the control word and, based on one or more signals output by the low-noise amplifier during the sweep, estimate one or more of a power gain, signal-to-noise ratio, and/or input reflection coefficient for each value of the control word;
determine an optimal value of the control word for use when the transceiver is operating in the receiver mode in an operation phase for that frequency based on said estimated power gains, signal-to-noise ratios and/or input reflection coefficients; and
store, in a non-volatile memory, a lookup table comprising the determined optimal value of the control word determined for each frequency of signal received.

24. The radio-frequency transceiver as claimed in claim 23 arranged in said operation phase, when operating in the receiver mode, to:
determine the frequency of a received signal;
retrieve from the lookup table stored the non-volatile memory an optimal value of the control word for the determined frequency; and
output the determined optimal value of the control word to the power amplifier.

25. A method of operating a radio-frequency transceiver, the method comprising:
in a transmitter mode, using a power amplifier comprising a switched-capacitor array comprising a plurality of capacitance elements to transmit one or more radio-frequency signals via an antenna; and
in a receiver mode:
using a low-noise amplifier to receive one or more radio-frequency signals via the antenna; and
pulling one or more of the capacitance elements in the switched-capacitor array to a ground potential.
